(19) United States
(12) Patent Application Publication
(10) Pub. No.: US 2007/0221343 A1
(43) Pub. Date: Sep. 27, 2007

(54) Slat for Venetian blind

(76) Inventor: Chin-Yu Chen, Changhua Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/386,569

(22) Filed: Mar. 22, 2006

(51) Int. Cl. E06B 3/12

(52) U.S. Cl. 160/236

(57) ABSTRACT

A slat for a Venetian blind includes a primary bamboo plate formed with two cord holes, a plurality of secondary bamboo plates mounted on two opposite sides of the primary bamboo plate, and a plurality of binding threads reeved around the primary bamboo plate and the secondary bamboo plates. Thus, each of the cord holes is entirely formed in the inside of the primary bamboo plate, so that each of the cord holes of the primary bamboo plate has a smooth peripheral wall to decrease the friction between the lift cord and each of the cord holes of the primary bamboo plate, to prevent the lift cord from being worn out or broken due to the friction, thereby enhancing the lifetime of the lift cord.

### BACKGROUND OF THE INVENTION

1. Field of the Invention

The present invention relates to a slat and, more particularly, to a slat for a Venetian blind.

2. Description of the Related Art

A conventional Venetian blind 1 in accordance with the prior art shown in FIG. 6 comprises a headrail 11, a bottom rail 12, a plurality of slats 13, two ladder cords 14, a lift cord 15, and a slat tilt rod 17. Each of the slats 13 has two cord holes 131. The lift cord 15 has two ends each extended through the respective cord hole 131 of each of the slats 13 and each attached to the bottom rail 12. However, each of the slats 13 is made of plastic material or aluminum, so that the slats 13 cannot satisfy the environmental protection requirement.

A conventional slat 2 in accordance with the prior art shown in FIG. 7 is made of bamboo and has two cord holes 21. Thus, the slat 2 is made of bamboo, so that the slat 2 satisfies the environmental protection requirement. However, the slat 2 has a larger area, thereby increasing the costs of fabrication. In addition, the slat 2 has a determined size, so that the worker has to cut the bamboo to fit the size of the slat 2, thereby incurring waste of the bamboo material.

Another conventional slat 3 in accordance with the prior art shown in FIG. 8 comprises a plurality of bamboo plates 31 laminating each other, and a plurality of binding threads 32 reeved around the bamboo plates 31 to bind the bamboo plates 31 together. Some of the bamboo plates 31 co-operate to form two cord holes 33.

Referring to FIGS. 9 and 10, the conventional slat 3 is available for a Venetian blind which comprises a bottom rail 12, two ladder cords 14, and a lift cord 15. The lift cord 15 has two ends each extended through the respective cord hole 33 of the bamboo plates 31 and each attached to the bottom rail 12. However, the bamboo plates 31 have gaps formed therebetween so that each of the two cord holes 33 has a plurality of sharp slits (or chamfered corners) 331 formed by the gaps between the bamboo plates 31 as shown in FIG. 10. Thus, the lift cord 15 rubs the sharp slits 331 of each of the two cord holes 33 frequently during movement, so that the lift cord 15 is easily worn out or broken by the sharp slits 331 of each of the two cord holes 33, thereby decreasing the lifetime of the lift cord 15.

### BRIEF SUMMARY OF THE INVENTION

In accordance with the present invention, there is provided a slat for a Venetian blind, comprising a primary bamboo plate formed with two cord holes, a plurality of serially arranged secondary bamboo plates mounted on two opposite sides of the primary bamboo plate, and a plurality of binding threads reeved around the primary bamboo plate and the secondary bamboo plates to bind the primary bamboo plate and the secondary bamboo plates together.

The primary objective of the present invention is to provide a slat for a Venetian blind, wherein each of the cord holes is entirely formed in the inside of the primary bamboo plate, so that each of the cord holes of the primary bamboo plate has a smooth peripheral wall to decrease the friction between the lift cord and each of the cord holes of the primary bamboo plate, to prevent the lift cord from being worn out or broken due to the friction, thereby enhancing the lifetime of the lift cord.

Another objective of the present invention is to provide a slat for a Venetian blind, wherein each of the cord holes is formed in a single primary bamboo plate, so that each of the cord holes of the primary bamboo plate is worked easily and rapidly, thereby enhancing the working efficiency for making the slat, and thereby decreasing the costs of fabrication.

A further objective of the present invention is to provide a slat for a Venetian blind, wherein the slat comprises a primary bamboo plate having a larger size co-operating with a plurality of secondary bamboo plates each having a smaller size, so that the slat has an outstanding outer appearance.

A further objective of the present invention is to provide a slat for a Venetian blind, wherein the secondary bamboo plates have the same width or diameter or have different width or diameter, so that the secondary bamboo plates are designed to present various spatial variations by changing the width and number of the secondary bamboo plates, thereby enhancing the aesthetic quality of the slat.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a slat in accordance with the preferred embodiment of the present invention.

FIG. 2 is a partially perspective view showing the slat as shown in FIG. 1 being mounted on a Venetian blind.

FIG. 3 is a locally enlarged view of the slat as shown in FIG. 2.

FIG. 4 is a perspective view of a slat in accordance with another preferred embodiment of the present invention.

FIG. 5 is a locally enlarged view of the slat as shown in FIG. 4.

FIG. 6 is a perspective view of a conventional Venetian blind in accordance with the prior art.

FIG. 7 is a perspective view of a conventional slat in accordance with the prior art.

FIG. 8 is a perspective view of another conventional slat in accordance with the prior art.

FIG. 9 is a partially perspective view showing the conventional slat as shown in FIG. 8 being mounted on a Venetian blind.

FIG. 10 is a locally enlarged view of the conventional slat as shown in FIG. 9.

### DETAILED DESCRIPTION OF THE INVENTION

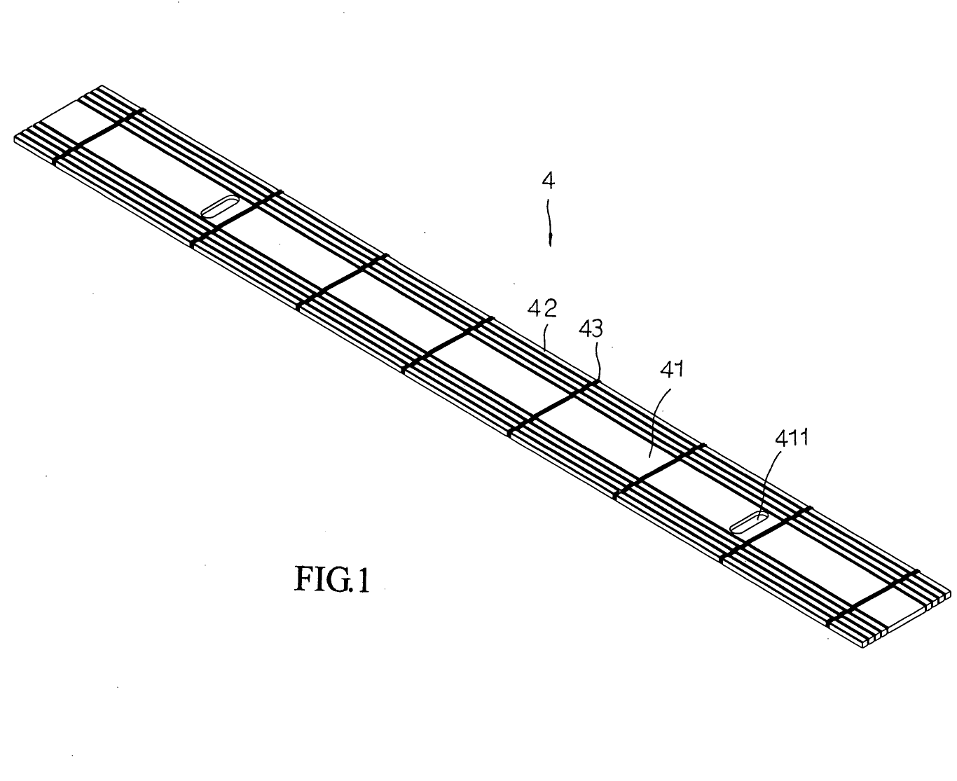

Referring to the drawings and initially to FIG. 1, a slat 4 for a Venetian blind in accordance with the preferred embodiment of the present invention comprises a primary bamboo plate 41 formed with two cord holes 411, a plurality of serially arranged secondary bamboo plates 42 mounted on two opposite sides of the primary bamboo plate 41, and a plurality of binding threads 43 reeved around the primary bamboo plate 41 and the secondary bamboo plates 42 to bind the primary bamboo plate 41 and the secondary bamboo plates 42 together. The primary bamboo plate 41 has a size greater than that of each of the secondary bamboo plates 42. The primary bamboo plate 41 has a width greater than a length of each of the cord holes 411, and each of the secondary bamboo plates 42 has a width smaller than the length of each of the cord holes 411. Preferably, the primary bamboo plate 41 and the secondary bamboo plates 42 are bonded closely by a bonding gel to reinforce a strength of the slat 4. Each of the cord holes 411 has two distal ends each located adjacent to an outer edge of the primary bamboo plate 41 as shown in FIG. 3.

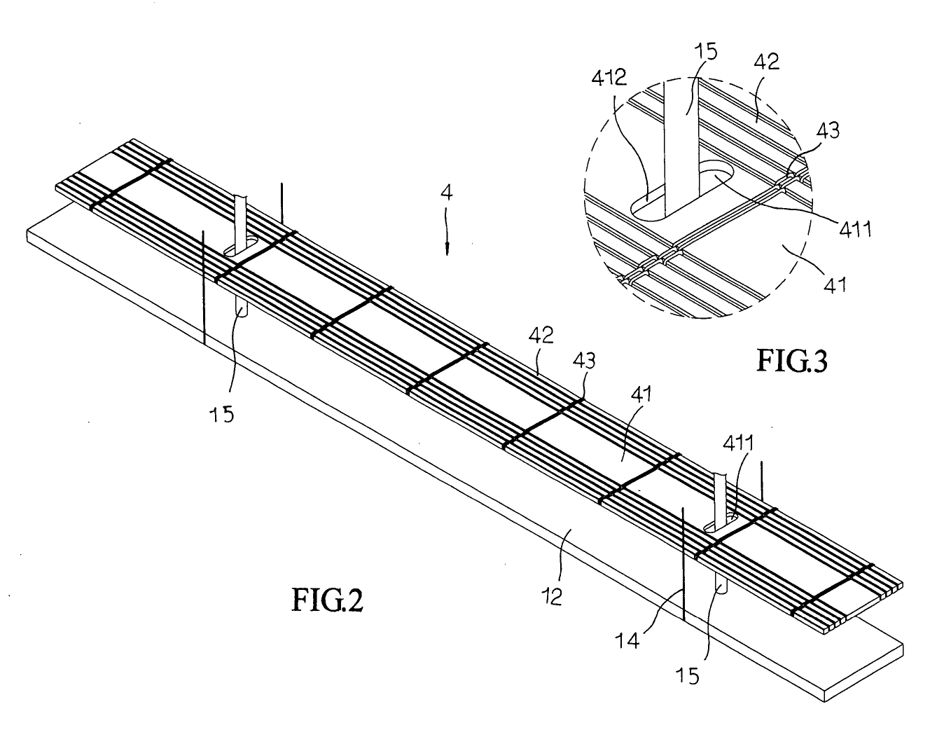

Referring to FIGS. 2 and 3, the slat 4 is available for a Venetian blind which comprises a bottom rail 12, two ladder cords 14, and a lift cord 15. The lift cord 15 has two ends each extended through the respective cord hole 411 of the primary bamboo plate 41 of the slat 4 and each attached to the bottom rail 12.

As shown in FIGS. 2 and 3, each of the cord holes 411 is entirely formed in an inside of the primary bamboo plate 41, so that each of the cord holes 411 of the primary bamboo plate 41 has a smooth peripheral wall 412 to decrease the friction between the lift cord 15 and each of the cord holes 411 of the primary bamboo plate 41, to prevent the lift cord 15 from being worn out or broken due to the friction, thereby enhancing the lifetime of the lift cord 15. In addition, each of the cord holes 411 is formed in a single primary bamboo plate 41, so that each of the cord holes 411 of the primary bamboo plate 41 is worked easily and rapidly, thereby enhancing the working efficiency for making the slat 4, and thereby decreasing the costs of fabrication. Further, the slat 4 comprises a primary bamboo plate 41 having a larger size co-operating with a plurality of secondary bamboo plates 42 each having a smaller size, so that the slat 4 has an outstanding outer appearance. Further, the secondary bamboo plates 42 have the same width or diameter or have different width or diameter, so that the secondary bamboo plates 42 are designed to present various spatial variations by changing the width and number of the secondary bamboo plates 42, thereby enhancing the aesthetic quality of the slat 4.

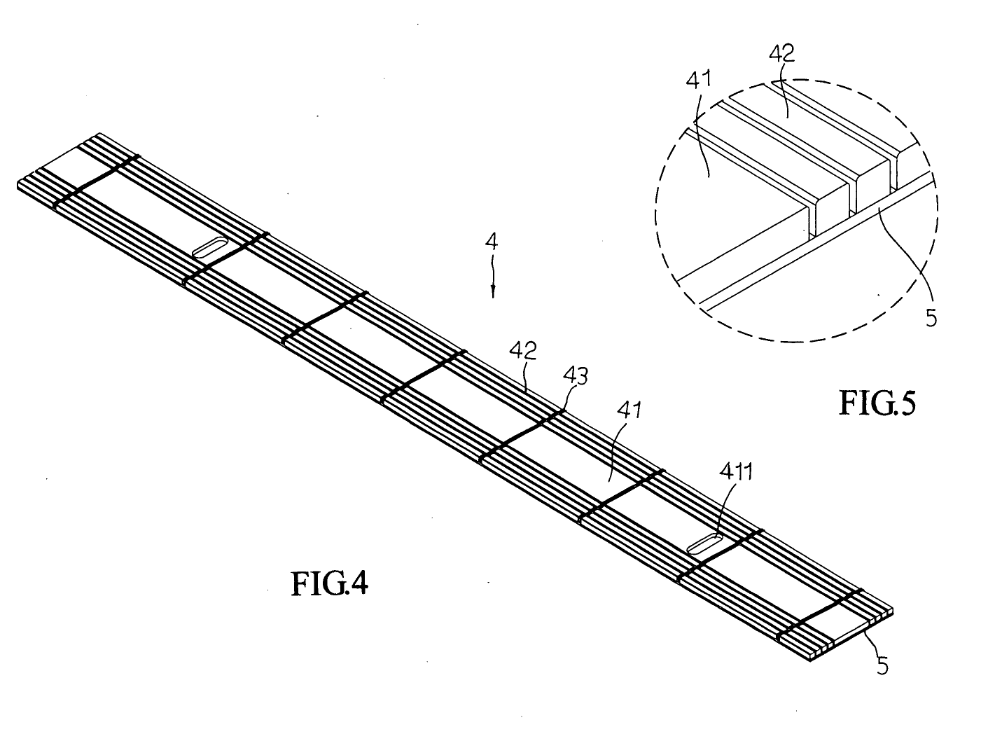

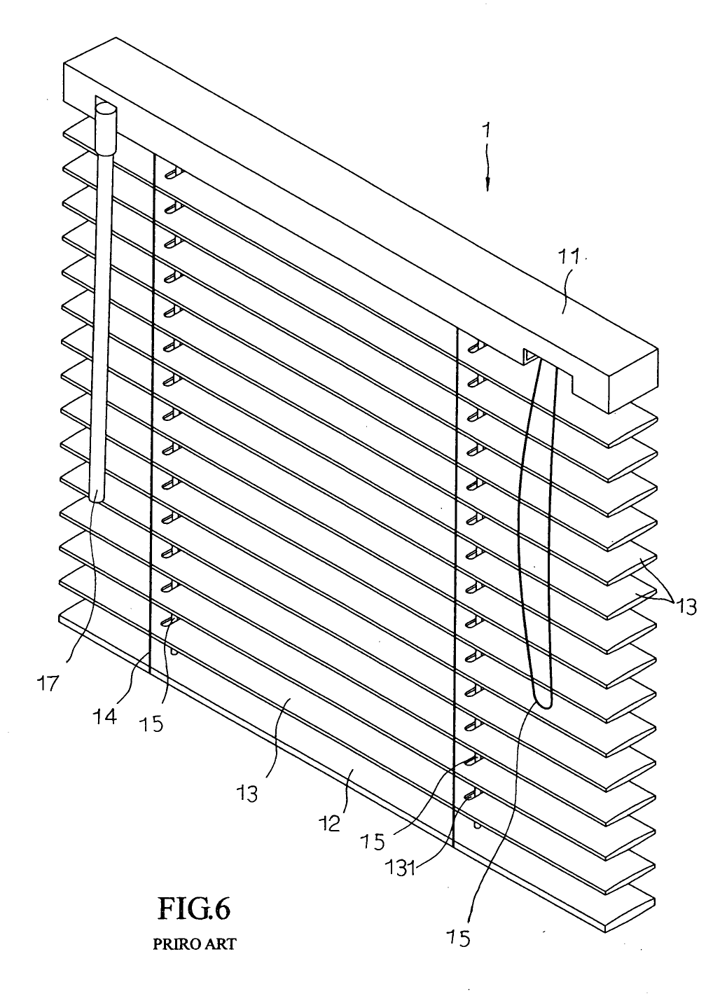

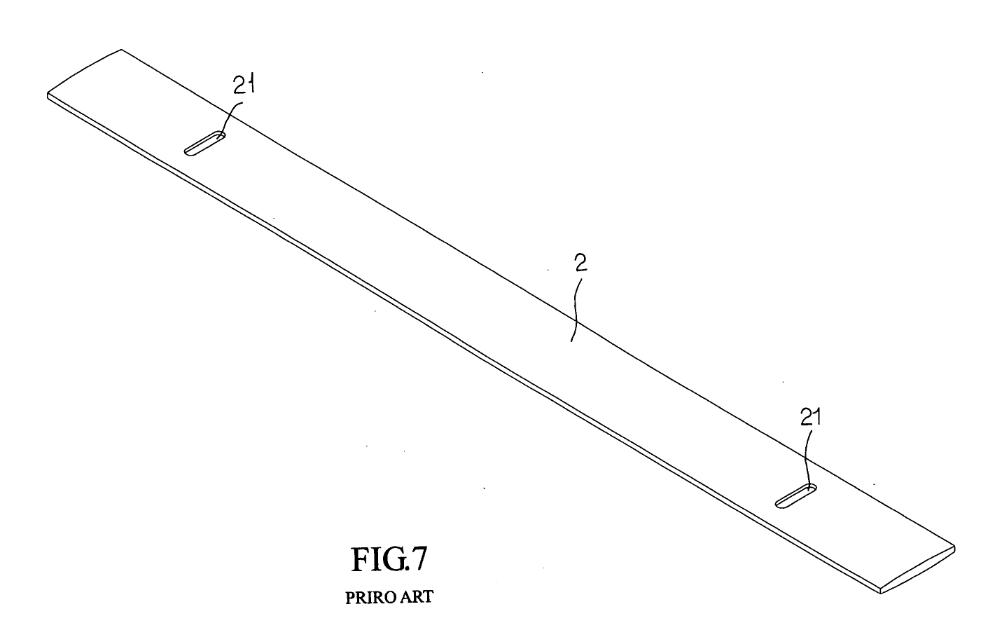

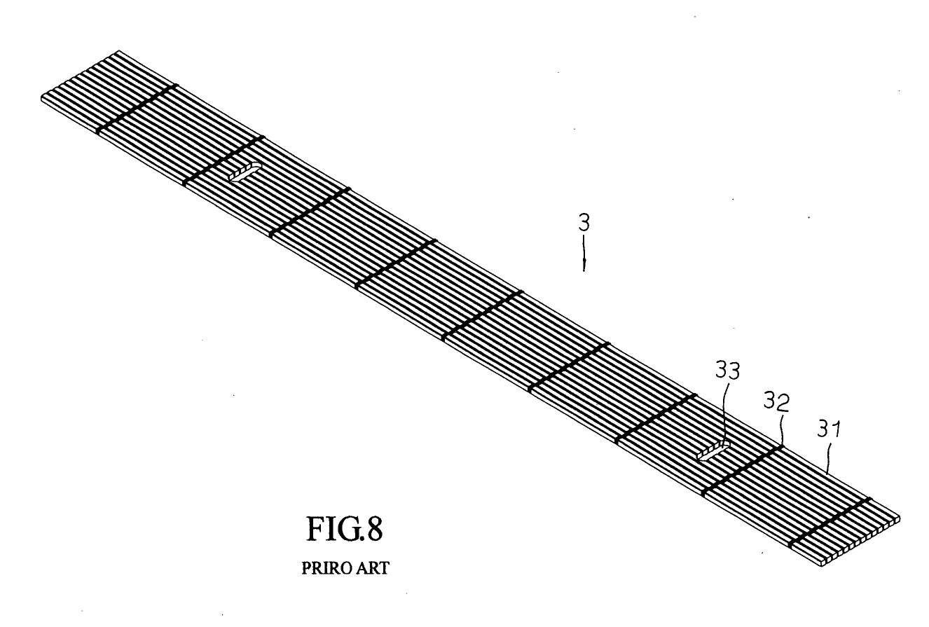

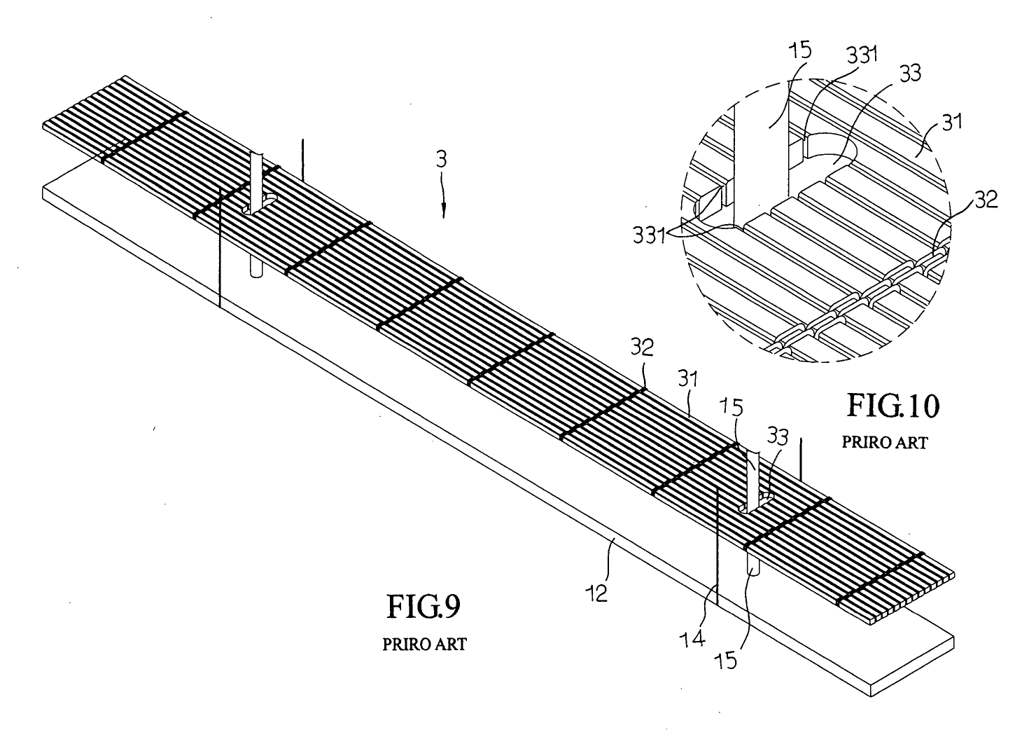

Referring to FIGS. 4 and 5, the slat 4 further comprises a non-woven fabric 5 bonded onto a bottom of the primary bamboo plate 41 and each of the secondary bamboo plates 42 to reinforce a strength of the slat 4.

Accordingly, each of the cord holes 411 is entirely formed in the inside of the primary bamboo plate 41, so that each of the cord holes 411 of the primary bamboo plate 41 has a smooth peripheral wall 412 to decrease the friction between the lift cord 15 and each of the cord holes 411 of the primary bamboo plate 41, to prevent the lift cord 15 from being worn out or broken due to the friction, thereby enhancing the lifetime of the lift cord 15. In addition, each of the cord holes 411 is formed in a single primary bamboo plate 41, so that each of the cord holes 411 of the primary bamboo plate 41 is worked easily and rapidly, thereby enhancing the working efficiency for making the slat 4, and thereby decreasing the costs of fabrication. Further, the slat 4 comprises a primary bamboo plate 41 having a larger size co-operating with a plurality of secondary bamboo plates 42 each having a smaller size, so that the slat 4 has an outstanding outer appearance. Further, the secondary bamboo plates 42 have the same width or diameter or have different width or diameter, so that the secondary bamboo plates 42 are designed to present various spatial variations by changing the width and number of the secondary bamboo plates 42, thereby enhancing the aesthetic quality of the slat 4.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A slat for a Venetian blind, comprising:
a primary bamboo plate formed with two cord holes;
a plurality of serially arranged secondary bamboo plates mounted on two opposite sides of the primary bamboo plate;
a plurality of binding threads reeved around the primary bamboo plate and the secondary bamboo plates to bind the primary bamboo plate and the secondary bamboo plates together.

2. The slat in accordance with claim 1, wherein the primary bamboo plate has a size greater than that of each of the secondary bamboo plates.

3. The slat in accordance with claim 1, wherein the primary bamboo plate has a width greater than a length of each of the cord holes.

4. The slat in accordance with claim 1, wherein each of the secondary bamboo plates has a width smaller than a length of each of the cord holes.

5. The slat in accordance with claim 1, wherein the primary bamboo plate and the secondary bamboo plates are bonded closely by a bonding gel to reinforce a strength of the slat.

6. The slat in accordance with claim 1, wherein each of the cord holes has two distal ends each located adjacent to an outer edge of the primary bamboo plate.

7. The slat in accordance with claim 1, wherein each of the cord holes is entirely formed in an inside of the primary bamboo plate, so that each of the cord holes of the primary bamboo plate has a smooth peripheral wall.

8. The slat in accordance with claim 1, wherein the secondary bamboo plates have the same width.

9. The slat in accordance with claim 1, wherein the secondary bamboo plates have different width.

10. The slat in accordance with claim 1, wherein the secondary bamboo plates have the same diameter.

11. The slat in accordance with claim 1, wherein the secondary bamboo plates have different diameter.

12. The slat in accordance with claim 1, further comprising a non-woven fabric bonded onto a bottom of the primary bamboo plate and each of the secondary bamboo plates to reinforce a strength of the slat.
